(19) United States
(12) Patent Application Publication
(10) Pub. No.: US 2008/0134231 A1
(43) Pub. Date: Jun. 5, 2008

(54) BROADCAST RECEIVING DEVICE

(75) Inventor: Takahiro KUROSE, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/947,256

(22) Filed: Nov. 29, 2007

(30) Foreign Application Priority Data
Dec. 1, 2006 (JP) 2006-325385

(51) Int. Cl. H04N 7/16

(52) U.S. Cl. 725/25

(57) ABSTRACT

A broadcast receiving device includes a table storage component, a setup condition storage component, a table acquisition component, a first determination component, a second determination component and a display control component. The table storage component stores a first viewing control table including first viewing control conditions. The setup condition storage component stores first setup condition information. The table acquisition component acquires a second viewing control table including second viewing control conditions via a television broadcast. The second determination component determines whether or not the first setup condition information includes a first viewing control execution indicator when the first determination component determines that the second viewing control table does not match the first viewing control table. The display control component displays information indicating that the second viewing control table is newly acquired when the second determination component determines that the first setup condition information includes the first viewing control execution indicator.

### CROSS-REFERENCE TO RELATED APPLICATIONS

This application claims priority to Japanese Patent Application No. 2006-325385 filed on Dec. 1, 2006. The entire disclosure of Japanese Patent Application No. 2006-325385 is hereby incorporated herein by reference.

### BACKGROUND OF THE INVENTION

1. Field of the Invention

The present invention generally relates to a broadcast receiving device. More specifically, the present invention relates to a broadcast receiving device for receiving television broadcasts.

2. Background Information

Broadcast receiving devices receive television broadcasts and output the television broadcasts to monitors so that the television broadcasts are visible from outside. The number of channels that can be viewed has been increasing with an increase of popularity of digital broadcasts. There are now more programs that include violence, obscenity, and so forth. Therefore, there is a growing need to control the programs that can be viewed by children, so that the children will not be exposed to such programs.

With some conventional television receivers, a user selects in advance a rating level to be subject to viewing control (see Japanese Laid-Open Patent Application 2000-354209, for example). Rating information indicating viewing control conditions is extracted from a television signal. Specifically, the rating information is transmitted with the television signal. Then, a received rating level corresponding to the rating information is identified. If the received rating level is equal to or lower than the selected rating level, then viewing control is executed. In other words, viewing of the television signal is blocked.

Meanwhile, on Mar. 15, 2006, the FCC (Federal Communications Commission) mandated that broadcast receiving devices shall include a function for acquiring an RRT (Rating Region Table) transmitted in a broadcast and updating a viewing control table (hereinafter referred to as a rating table) based on the acquired RRT (see Code of Federal Regulations, Title 47—Telecommunication, Chapter I, §15.120, “Program blocking technology requirements for television receivers”). The rating table is a table that specifies viewing control conditions preset according to positions in a column direction and positions in a row direction.

However, with the conventional television receiver, mentioned above, when the rating table is updated based on an acquired RRT, the user is unaware that the rating table has been updated. Therefore, the updated rating table can not be effectively used by the user. Also, when the viewing control is executed based on the updated rating table, the user has to set whether or not the viewing control is to be executed for every one of the viewing control conditions stored in the updated rating table. In other words, the user has to set whether or not the viewing of programs is to be blocked according to the viewing control conditions stored in the updated rating table.

In view of the above, it will be apparent to those skilled in the art from this disclosure that there exists a need for an improved television receiving device. This invention addresses this need in the art as well as other needs, which will become apparent to those skilled in the art from this disclosure.

### SUMMARY OF THE INVENTION

The present invention was conceived in light of the above-mentioned problems. One object of the present invention is to provide a broadcast receiving device with which a new viewing control table is effectively utilized.

In accordance with one aspect of the present invention, a broadcast receiving device for receiving a television broadcast includes a table storage component, a setup condition storage component, a table acquisition component, a first determination component, a second determination component and a display control component. The table storage component is configured to store a first viewing control table including first viewing control conditions for viewing control. The setup condition storage component is configured to store a first setup condition information corresponding to the first viewing control table. The first setup condition information indicates whether or not the viewing control is to be executed based on the first viewing control conditions of the first viewing control table. The table acquisition component is configured to acquire a second viewing control table including second viewing control conditions for the viewing control via the television broadcast. The first determination component is configured to determine whether or not the second viewing control table acquired by the table acquisition component matches the first viewing control table stored in the table storage component. The second determination component is configured to determine whether or not the first setup condition information stored in the setup condition storage component includes a first viewing control execution indicator indicating that the viewing control is to be executed based on one of the first viewing control conditions of the first viewing control table, when the first determination component determines that the second viewing control table acquired by the table acquisition component does not match the first viewing control table stored in the table storage component. The display control component is configured to display information indicating that the second viewing control table is newly acquired when the second determination component determines that the first setup condition information includes the first viewing control execution indicator.

With the broadcast receiving device of the present invention, it is possible to provide a broadcast receiving device with which a new viewing control table effectively utilized.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram illustrating a broadcast receiver in accordance with one embodiment of the present invention;

FIG. 2 is a plan view of a remote control of the broadcast receiver illustrated in FIG. 1;

FIG. 3 is a block diagram illustrating a functional configuration of the broadcast receiver illustrated in FIG. 1;

FIG. 4A is a diagram illustrating a stored viewing control table;

FIG. 4B is a diagram illustrating a new viewing control table;

FIG. 5 is a screen shot of a setup requirement determination screen displayed by a display control component; and

FIG. 6 is a flowchart illustrating an operation of the digital broadcast receiver illustrated in FIG. 1.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

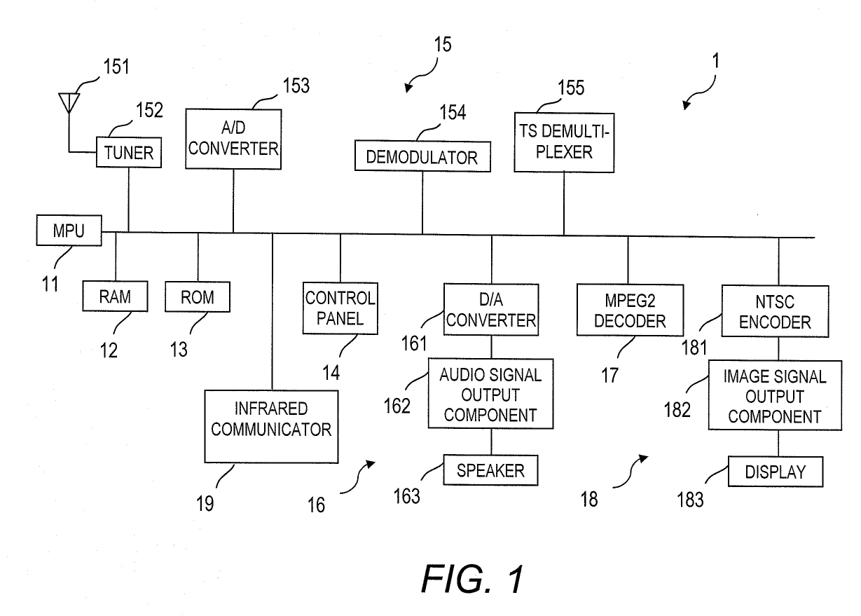

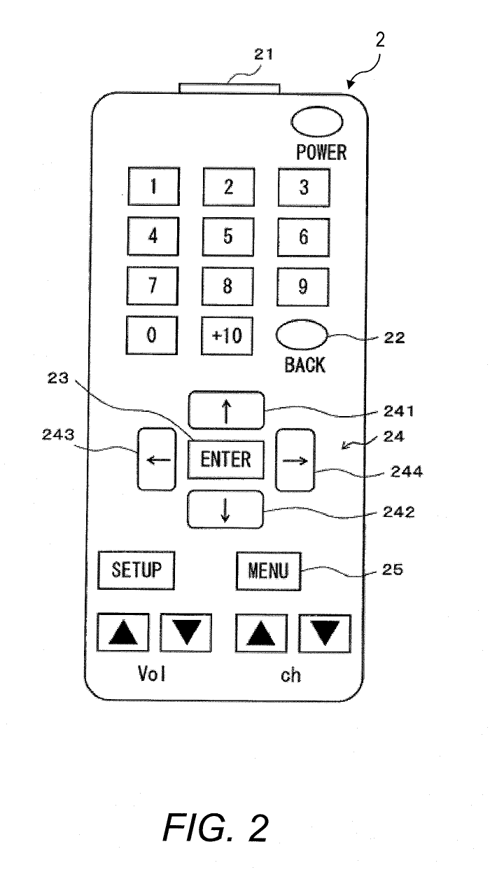

FIG. 1 is a block diagram illustrating a digital broadcast receiver 1. The digital broadcast receiver 1 (e.g., broadcast receiving device) is communicably connected to a remote controller 2 (hereinafter referred to as “remote”) shown in FIG. 2 via infrared communication.

The digital broadcast receiver 1 receives an operation input from a user via the remote 2. The digital broadcast receiver 1 receives television broadcasts and outputs one of the television broadcasts to a display 183. The digital broadcast receiver 1 includes an MPU (Micro Processing Unit) 11, a RAM (Random Access Memory) 12, a ROM (Read Only Memory) 13, a control panel 14, a reception component 15, an audio output component 16, an MPEG-2 (Motion Picture Experts Group) decoder 17, an image output component 18 and an infrared communicator 19.

The MPU 11 controls an operation of the entire digital broadcast receiver 1. The RAM 12 readably and writably stores information such as audio information and video information. The ROM 13 stores a control program for operating the MPU 11, for example.

The control panel 14 is used to perform various operations, such as turning the power on and off, and changing the channel. The reception component 15 (e.g., table acquisition component) receives and demodulates television broadcasts. The reception component 15 includes an antenna 151, a tuner 152, an A/D converter 153, a demodulator 154, and a TS demultiplexer 155.

The antenna 151 receives television broadcast waves. The tuner 152 tunes in a preset channel from the television broadcast waves received by the antenna 151. The A/D converter 153 converts an analog output signal of the tuner 152 into a digital signal. The demodulator 154 demodulates output information from the A/D converter 153. The TS demultiplexer 155 separates the output information demodulated by the demodulator 154 by type, and outputs audio information and video information.

The audio output component 16 outputs the audio corresponding to the television broadcast received by the reception component 15. The audio output component 16 includes a D/A converter 161, an audio signal output component 162 and a speaker 163. The D/A converter 161 converts the audio information outputted from the TS demultiplexer 155 (digital information) into an analog audio signal. The audio signal output component 162 outputs the analog audio signal to the speaker 163. The speaker 163 outputs audio corresponding to the analog audio signal.

The MPEG 2 decoder 17 decodes the video information outputted from the TS demultiplexer 155 into pre-compression video information.

The image output component 18 outputs the video information decoded by the MPEG2 decoder 17. The image output component 18 includes an NTSC (National Television Standards Committee) encoder 181, an image signal output component 182 and a display 183 (e.g., monitor). The NTSC encoder 181 converts the video information decoded by the MPEG2 decoder 17 into an NTSC-format television signal. The image signal output component 182 outputs the NTSC-format television signal to the display 183. The display 183 is a display device such as an LCD (Liquid Crystal Display), PDP (Plasma Display Panel), or the like. The display 183 displays video corresponding to the NTSC-format television signal outputted from the image signal output component 182.

The infrared communicator 19 is used to perform various operations from the remote 2, such as turning the power on and off, changing the channel, and changing settings of the digital broadcast receiver 1 (such as viewing control settings).

The digital broadcast receiver 1 receives the television broadcasts as follows. First, a transmitted digital broadcast wave is received by the antenna 151. When the control panel 14 is used to tune in a channel, switching of a transponder or a channel received by the tuner 152 is performed. The received digital broadcast wave is converted into digital information by the A/D converter 153, and demodulated by the demodulator 154.

The digital broadcast wave is transmitted from a transmitting side (transmitting station) as a TS (Transport Stream) packet. The TS packet includes the video information, the audio information, control information including viewing control table information, and so forth. The viewing control table information further includes a viewing control table having viewing control conditions. The video information, the audio information and the control information are separated and outputted by the TS demultiplexer 155. Then, the video information, the audio information and the control information are stored in the RAM 12. The audio information is read out from the RAM 12, and is converted into an analog audio signal by the D/A converter 161. Then, audio is outputted from the speaker 163 via the audio signal output component 162.

Also, the video information is read out from the RAM 12, and is decoded into pre-compression video information by the MPEG2 decoder 17. Then, the pre-compression video information is converted into an NTSC-format television signal by the NTSC encoder 181. Then, a video image is displayed on the display 183 via the image signal output component 182.

The remote 2 receives operation input from a user. The remote 2 produces an infrared signal corresponding to the operation input. Then, the remote 2 outputs the infrared signal to the digital broadcast receiver 1. The remote 2 includes an infrared signal output component 21, a back key 22, an enter key 23, direction keys 24 and a menu key 25. The infrared signal output component 21 produces an operation signal corresponding to a key pressed by the user. The infrared signal output component 21 converts the signal into the infrared signal. Then, the infrared signal output component 21 transmits the signal to the digital broadcast receiver 1.

The back key 22 is pressed to return a currently displayed screen to an original screen. The enter key 23 is pressed to set various settings, such as the viewing control conditions of the digital broadcast receiver 1. The direction keys 24 are pressed to select one of a plurality of categories that can be selected and are displayed on the display 183. The direction keys 24 include an up key 241, a down key 242, a left key 243 and a right key 244. The up key 241 is a key for moving a selection state upward. The down key 242 is a key for moving the selection state downward. The left key 243 is a key for moving the selection state to the left. The right key 244 is a key for moving the selection state to the right. The menu key 25 is pressed to display a menu screen when setting various settings, such as the viewing control conditions of the digital broadcast receiver 1.

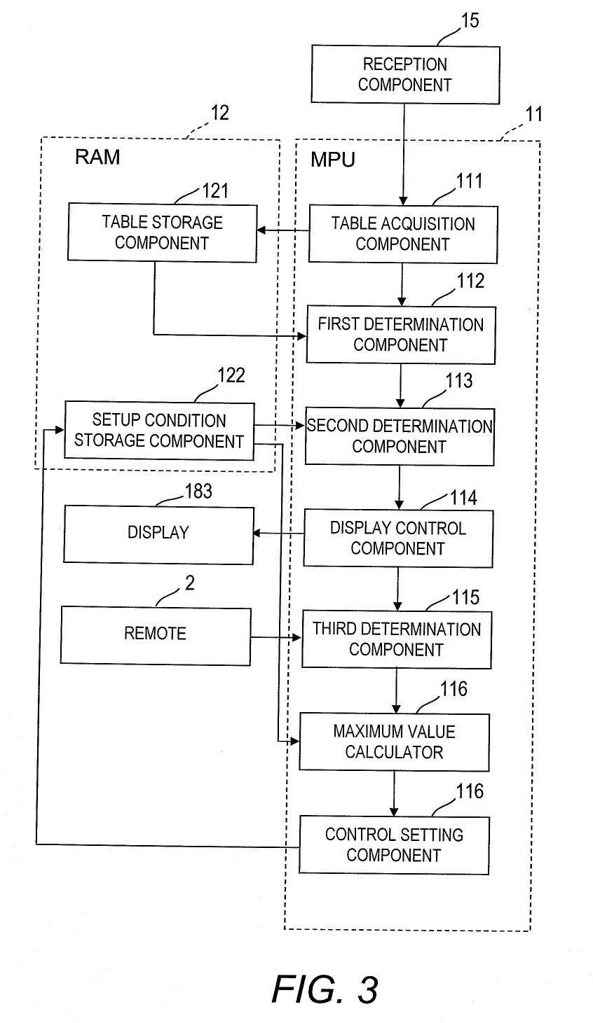

FIG. 3 is a block diagram illustrating a functional configuration of the broadcast receiver 1. The MPU 11 functionally includes a table acquisition component 111, a first determination component 112, a second determination component 113, a display control component 114, a third determination component 115, a maximum value calculator 116 and a condition production component 117. The RAM 12 functionally includes a table storage component 121 and a setup condition storage component 122.

The MPU 11 reads and executes a control program that has been pre-stored in the ROM 13, etc., shown in FIG. 1. Then, the MPU 11 functions as the table acquisition component 111, the first determination component 112, the second determination component 113, the display control component 114, the third determination component 115, the maximum value calculator 116, the condition production component 117, or another such functional component. Also, the MPU 11 causes the RAM 12 to function as the table storage component 121, the setup condition storage component 122, or another such functional component.

Data stored in the RAM 12 and ROM 13 can be stored on a removable recording medium such as a hard disk, optical disk, flexible disk, CD (Compact Disk), DVD (Digital Versatile Disk), semiconductor memory, or the like. In this case, the data can be readable by a hard disk drive, optical disk drive, flexible disk drive, silicon disk drive, cassette medium reader, or other such driver.

The table storage component 121 stores the viewing control table information acquired by the table acquisition component 111. The viewing control table information further includes the viewing control table.

The viewing control table is a table in which viewing control conditions are preset and specified according to positions in a column direction and positions in a row direction. Furthermore, each column of the viewing control table includes the viewing control conditions ranked in the order of rating levels from the lowest rating to the highest rating as the row number become larger. Specifically, each column of the viewing control table includes the viewing control conditions indicating that a program is more appropriate for younger viewers as the row number increases. In other words, a program that is intended for younger viewers and has a high rating level can be blocked with a stricter viewing control. A program that is intended for older viewers and has a low rating level can be blocked with a looser viewing control.

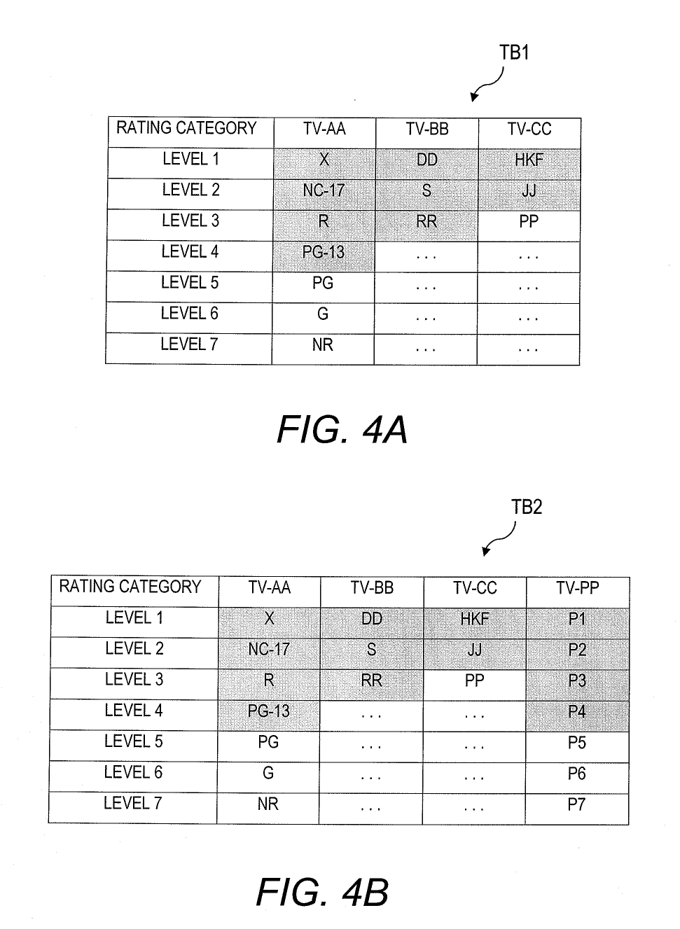

FIG. 4A is a diagram illustrating a stored viewing control table TB1 (e.g., first viewing control table) that is a viewing control table stored in the table storage component 121 prior to update. The stored viewing control table TB1 including viewing control conditions (e.g., first viewing control conditions). FIG. 4B is a diagram illustrating a new viewing control table TB2 (e.g., second viewing control table) that is a viewing control table newly acquired by the table acquisition component 111 and replaced with the stored viewing control table TB1. The new viewing control table TB2 including viewing control conditions (e.g., second viewing control conditions). As shown in FIG. 4A, the first column of the stored viewing control table TB1 includes viewing control conditions having a rating category name “TV-AA”. The viewing control conditions “TV-AA” includes ratings according to MPAA (Motion Picture Association of America) standards. Specifically, beginning with the first row in the first column, the viewing control conditions “TV-AA” include following viewing control conditions: X, NC-17, R, PG-13, PG, G, and NR.

The X in the first row is a rating that is an old version of the NC-17. The NC-17 (No Children under 17, or No One 17 And Under Admitted) in the second row means that no one under 18 years old (17 years or under) is admitted to enjoy the viewing. The R (Restricted) in the third row means that an accompanying a parent or a guardian is required.

The PG-13 (Parents strongly cautioned) in the fourth row means that a parent or a guardian must exercise caution over viewing by a child under 13 years old (12 years or under). The PG (Parental Guidance suggested) in the fifth row means that it is recommended that a parent or a guardian check the content before it is viewed by a child. The G (General audiences) in the sixth row means the work is suitable for all ages. The NR (Not Rated) in the seventh row means that there is no viewing control.

The stored viewing control table TB1 further includes viewing control conditions having a rating category name “TV-BB” and viewing control conditions having a rating category name “TV-CC”.

The setup condition storage component 122 stores setup condition information (e.g., first setup condition information). The setup condition information indicates whether or not each of the viewing controls corresponding to each of the viewing control conditions stored in the viewing control table is to be executed. In other words, the setup condition information indicates whether or not the viewing of programs is to be blocked with each of the viewing control conditions stored in the viewing control table. The setup condition information is produced by the condition production component 117. For example, the stored viewing control table TB 1 shown in FIG. 4A includes 21 total viewing control conditions (seven rows and three columns). Thus, the setup condition storage component 122 stores the setup condition information corresponding to each of the 21 viewing control conditions. Specifically, the setup condition information includes viewing control execution indicators. The viewing control execution indicators are set for the viewing control conditions stored in the viewing control table, with which the viewing control is to be executed (that is, the viewing control execution indicators are set for the viewing control conditions with which viewing of programs is to be blocked. In other words, the viewing control execution indicators are information indicating that viewing control is to be executed.

The table acquisition component 111 acquires an RRT (Rating Region Table; e.g., viewing control table information) received via the reception component 15. The table acquisition component 111 produces the viewing control table based on the acquired RRT. Then, the table acquisition component 111 stores the viewing control table in the table storage component 121 as an acquired viewing control table.

The first determination component 112 determines whether or not the acquired viewing control table newly acquired by the table acquisition component 111 matches the stored viewing control table TB1 stored in the table storage component 121. More specifically, the first determination component 112 determines whether or not there is a match based on the “dimension_name_text” included in the RRT (hereinafter referred to as “rating category name information”).

Specifically, the first determination component 112 determines whether or not the rating category name information included in the acquired viewing control table matches the rating category name information included in the stored viewing control table. The rating category name information corresponds to the rating category names shown in FIGS. 4A and B (“TV-AA”, “TV-BB”, “TV-CC”, “TV-PP”, etc.).

The second determination component 113 determines whether or not at least one viewing control execution indicator is stored in the setup condition information when the first determination component 112 determines that there is no match. In other words, the second determination component 113 determines whether or not at least one viewing control execution indicator is stored in the setup condition information when it has been determined that the acquired viewing control table is to be replaced with the stored viewing control table TB1 as the new viewing control table TB2.

The display control component 114 visibly displays guidance information via an OSD (On Screen Display) on the display 183 only when the second determination component 113 determines that the viewing control execution indicator is stored in the setup condition information.

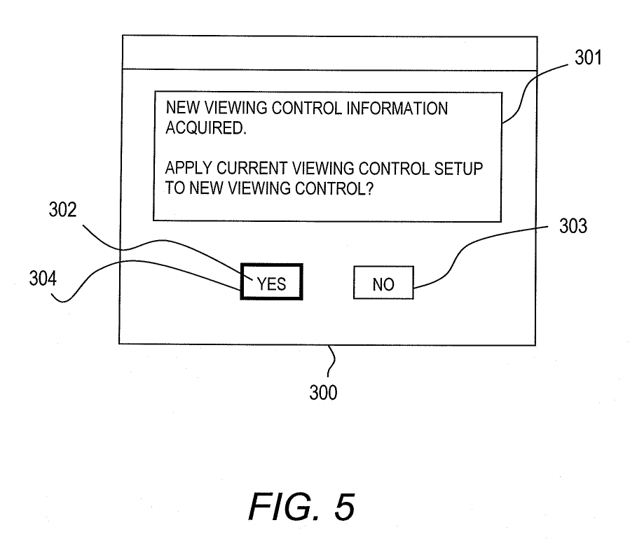

The guidance information indicates that the new viewing control table TB2 has been acquired. Also, as shown in FIG. 5, the display control component 114 displays the guidance information together with a Yes button 302 and a No button 303 within a setup requirement determination screen 300 on the display 183. The Yes button 302 is selected when the viewing control is to be executed using the new viewing control table TB2 updated by the third determination component 115. The No button 303 is selected when the viewing control is not to be executed using the new viewing control table TB2 updated by the third determination component 115.

The third determination component 115 receives the operation input from the user via the remote 2 only when the second determination component 113 determines that viewing control execution indicator is stored in the setup condition information. Then, the third determination component 115 determines whether or not the viewing control is to be executed using the new viewing control table TB2 based on the received operation input. Also, the third determination component 115 determines whether or not the viewing control is to be executed via the displayed setup requirement determination screen 300.

FIG. 5 is a screen shot of the setup requirement determination screen 300 displayed by the display control component 114. A guidance display section 301 is displayed in the approximate middle of the setup requirement determination screen 300. The Yes button 302 and the No button 303 are displayed under the guidance display section 301. Furthermore, a selection mark 304 is displayed on the Yes button 302, which indicates that the Yes button 302 is selected. The guidance display section 301 displays the guidance information indicating that new viewing control table TB2 has been acquired. In the guidance display section 301, a message saying “New viewing control information acquired” is displayed. The guidance display section 301 also displays guidance information related to a method for operating the setup requirement determination screen 300. Specifically, a message saying “Apply current viewing control setup to new viewing control?” is displayed.

The Yes button 302 is selected when the viewing control is to be executed using the new viewing control table TB2. The No button 303 is selected when viewing control is not to be executed using the new viewing control table TB2. The selection mark 304 indicates a selection state.

When the Yes button 302 is selected (the initial state), if an operation signal corresponding to the right key 244 on the remote 2 has been received, then the third determination component 115 produces a state in which the No button 303 is selected. Then, the selection mark 304 is moved onto the No button 303 by the display control component 114. When the No button 303 is selected, if an operation signal corresponding to the left key 243 on the remote 2 has been received, then the third determination component 115 produces a state in which the Yes button 302 is selected. Then, the selection mark 304 is moved onto the Yes button 302 by the display control component 114.

When the Yes button 302 is selected with the selection mark 304, if an operation signal corresponding to the enter key 23 on the remote 2 has been received, then the third determination component 115 sets the viewing control to be executed. When the No button 303 is selected with the selection mark 304, if an operation signal corresponding to the enter key 23 on the remote 2 has been received, then the third determination component 115 sets the viewing control not to be executed.

The maximum value calculator 116 calculates a maximum row number value. The maximum row number value is the maximum value of the row numbers of the rows which store viewing control conditions for which the viewing control execution indicators have been set.

Specifically, as shown by shadings in FIG. 4A, for the viewing control conditions “TV-AA” stored in the first column, the viewing control conditions stored in the first to fourth rows are set so that the viewing control will be executed (that is, for the viewing control conditions stored in the first to forth rows of the first column, the viewing control execution indicators are stored in the setup condition information). For the viewing control conditions “TV-BB” stored in the second column, the viewing control conditions stored in the first to third rows are set so that the viewing control will be executed. For the viewing control conditions “TV-CC” stored in the third column, the viewing control conditions stored in the first and second rows are set so that the viewing control will be executed. In this case, the maximum value calculator 116 finds that the maximum row number value is “4.”

The condition production component 117 produces a setup condition information (second setup condition information) corresponding to the new viewing control table TB2 according to preset rules when the third determination component 115 determines that the viewing control is to be executed. Then, the condition production component 117 stores the setup condition information in the setup condition storage component 122.

More specifically, the condition production component 117 sets the viewing control execution indicators in the setup condition information. In particular, the condition production component 117 sets the viewing control execution indicators for the viewing control conditions that are newly acquired in the new viewing control table TB2 compared to the stored viewing control table TB1, and that are stored in the rows having row numbers less than or equal to the maximum row number value.

For example, as shown in FIG. 4B, the table acquisition component 111 acquires the new viewing control table TB2 including a fourth column including viewing control conditions “TV-PP”. The condition production component 117 sets the viewing control indicators for the viewing control conditions stored in the first to fourth rows of the fourth column based on the maximum row number value so that viewing control will be executed. In other words, the viewing control execution indicators are stored in the setup condition information corresponding to the first to fourth rows of the new viewing control table TB2 as indicated by the shading in FIG. 4B.

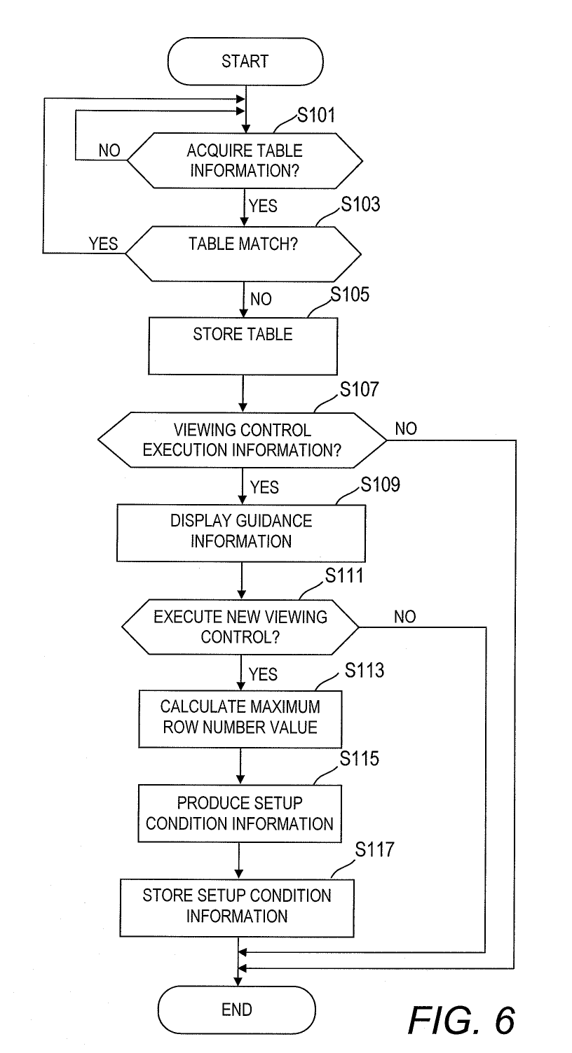

FIG. 6 is a flowchart illustrating an operation of the digital broadcast receiver 1. The RRT is received by the table acquisition component 111 via the reception component 15. The stored viewing control table TB1 is produced based on the acquired RRT. Then, the stored viewing control table TB1 is stored in the table storage component 121.

First, it is determined whether or not the viewing control table has been acquired (S101). If it is determined that the viewing control table has not been acquired (No in S101), then the processing enters a standby state. If it is determined that the viewing control table has been acquired (Yes in S101), then the first determination component 112 determines whether or not the acquired viewing control table matches the stored viewing control table TB1 stored in the table storage component 121 (S103).

If it is determined that there is a match (Yes in S103), then the processing returns to step S101, and the processing from step S101 is repeated. If it is determined that there is no match (No in S103), then the table acquisition component 111 stores the acquired viewing control table in the table storage component 121 as the new viewing control table TB2 (S105). Then the second determination component 113 determines whether or not at least one the viewing control execution indicators is stored in the setup condition information in the setup condition storage component 122 (S107).

If it is determined that the viewing control execution indicator has not been stored (No in S107), then the processing ends. If it is determined that the viewing control execution indicator has been stored (Yes in S107), then the display control component 114 displays on the display 183 the guidance information indicating that new viewing control table TB2 has been acquired (S109). Then, the third determination component 115 determines whether or not the viewing control is to be executed using the new viewing control table TB2 (S111). If it is determined that the viewing control is not to be executed (No in S111), then the processing ends.

If it is determined that the viewing control is to be executed (No in S111), then the maximum value calculator 116 finds the maximum row number value in the stored viewing control table TB1 (S113). Then, the condition production component 117 produces setup condition information corresponding to the new viewing control table TB2 based on the maximum row number value found in step S113. The condition production component 117 stores the setup condition information produced in step S115 in the setup condition storage component 122 (S117), and the processing ends.

With the digital broadcast receiver 1, the viewing control conditions that have been preset according to the position in the column direction and the position in the row direction are specified. Furthermore, the stored viewing control table TB1 is stored in the table storage component 121. Also, the setup condition information is stored in the setup condition storage component 122 corresponding to the position in the column direction and the position in the row direction of the stored viewing control table TB1. The setup condition information indicates whether or not the viewing control is to be executed using the corresponding viewing control conditions. The acquired viewing control table is acquired by the reception component 15. Then, it is determined whether or not the acquired viewing control table matches the stored viewing control table TB1. If it is determined that there is no match (that is, that the stored viewing control table TB1 has been updated), then it is determined whether or not the viewing control execution indicator is stored in the setup condition information in the setup condition storage component 122. Further, the guidance information is visibly displayed on the display 183. The guidance information indicates that the new viewing control table TB2 has been acquired. The guidance information is displayed only when it has been determined that the viewing control execution indicator is stored in the setup condition information. Therefore, the new viewing control table TB2 is effectively utilized.

Specifically, when the stored viewing control table TB1 has been updated, the guidance information is displayed. Therefore, the user can ascertain via the display 183 that the stored viewing control table TB1 has been updated. Thus, the new viewing control table TB2 is effectively utilized.

Also, since the guidance information is displayed in the setup requirement determination screen 300 on the display 183 only when the viewing control execution indicator has been stored. This prevents unnecessary guidance information from being displayed on the display 183 when the viewing control execution indicator has not been stored. Therefore, the system becomes more convenient to use.

For example, some users never set the digital broadcast receiver 1 to execute the viewing control since the users are not interested in viewing control, or do not need for the viewing control to be performed. When the digital broadcast receiver 1 is used by such users, it is assumed that the viewing control execution indicator has not been stored in the digital broadcast receiver 1. Thus, the guidance information that is unnecessary (or of no interest) to the users will be prevented from being displayed on the display 183. Therefore, the system becomes more convenient to use.

Further, the operation input from the user is received via the remote 2. Then, it is determined whether or not the viewing control is to be executed using the new viewing control table TB2 based on the received operation input. If it has been determined that the viewing control is to be executed, then the setup condition information corresponding to the new viewing control table TB2 is produced. Then, the setup condition information is stored in the setup condition storage component 122. Therefore, the new viewing control table TB2 can be effectively utilized.

Specifically, since the setup condition information corresponding to the new viewing control table TB2 is produced in accordance with preset rules. Then, the setup condition information is stored in the setup condition storage component 122. Thus, the user does not need to set the setup condition information corresponding to the new viewing control table TB2. Therefore, the new viewing control table TB2 can be effectively utilized.

Also, the operation input from the user is received. Then, it is determined whether or not the viewing control is to be executed using the new viewing control table TB2 based on the received operation input. If it is determined that the viewing control is to be executed, then the setup condition information corresponding to the new viewing control table TB2 is produced. Therefore, if it is determined that viewing control is not to be executed using the new viewing control table TB2 (that is, if the user has performed operation input indicating that the viewing control is not to be executed using the new viewing control table TB2), then no setup condition information corresponding to new viewing control table TB2 will be produced. Thus, excessive viewing control is prevented from being executed. Furthermore, the system becomes more convenient to use.

In addition, the maximum row number value for the stored viewing control table TB2. Then, the viewing control execution indicator is set for the rows of the new viewing control table TB2 having row numbers less than or equal to the maximum row number value. Therefore, proper setup conditions can be set.

The viewing control table is a table storing the viewing control conditions so that the viewing control conditions are ranked in the order of rating levels from the lowest rating to the highest rating as the row number increases in each column. Thus, the maximum row number value is the number of the row which stores a viewing control condition having the highest rating level out of the viewing control conditions stored in the viewing control table TB1, for which the viewing control execution indicators are set. Therefore, for the viewing control conditions stored in the rows having row numbers less than or equal to the maximum row number value, the viewing control execution indicators are set. In other words, viewing of programs is blocked for the programs having the viewing control conditions stored in the new viewing control table TB2, for which the viewing control execution indicators. Therefore, the viewing control is executed properly.

The broadcast receiver 1 can be any type of broadcast receiving device that receives television broadcasts and outputs the television broadcasts to the display 183 so that the television broadcasts are visible from outside. For instance, the broadcast receiving device can be a device that receives analog broadcasts or both analog and digital broadcasts. However, the broadcast receiver 1 has a function for acquiring the viewing control table information corresponding to the RRT.

The display 183 can be configured as a device that is separate from the digital broadcast receiver 1. For example, the display 183 can be a monitor provided to a personal computer or the like.

The third determination component can receive the operation input from the user via the control panel 14 instead of the remote 2.

In this embodiment, the condition production component 117 sets the viewing control execution indicator for rows having row numbers less than or equal to the maximum row number value. However, the setup condition information can be produced in accordance with other preset rules.

For example, an average value can be calculated for row numbers of rows of the stored viewing control table TB1, which stores the viewing control conditions for which the viewing control execution indicators are set. Then, the viewing control conditions stored in the rows of the new viewing control table TB2, which have row numbers less than or equal to the average value. Also, the condition production component 117 can display the maximum row number value via an OSD or the like so as to be visible to the user and allow the user to input an operation input via the remote 2. Then, the setup condition information is produced based on the received operation input.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A broadcast receiving device for receiving a television broadcast, comprising:
a table storage component configured to store a first viewing control table including first viewing control conditions for viewing control;
a setup condition storage component configured to store first setup condition information corresponding to the first viewing control table, the first setup condition information indicating whether or not the viewing control is to be executed based on the first viewing control conditions of the first viewing control table;
a table acquisition component configured to acquire a second viewing control table including second viewing control conditions for the viewing control via the television broadcast;
a first determination component configured to determine whether or not the second viewing control table acquired by the table acquisition component matches the first viewing control table stored in the table storage component;
a second determination component configured to determine whether or not the first setup condition information stored in the setup condition storage component includes a first viewing control execution indicator indicating that the viewing control is to be executed based on one of the first viewing control conditions of the first viewing control table, when the first determination component determines that the second viewing control table acquired by the table acquisition component does not match the first viewing control table stored in the table storage component; and
a display control component configured to display information indicating that the second viewing control table is newly acquired when the second determination component determines that the first setup condition information includes the first viewing control execution indicator.

2. The broadcast receiving device according to claim 1, wherein
the first viewing control table is configured to store each of the first viewing control conditions according to a row number and a column number, and
the second viewing control table is configured to store each of the second viewing control conditions according to a row number and a column number.

3. The broadcast receiving device according to claim 2, wherein
the first and second viewing control tables are configured to store the first and second viewing control conditions so that the first and second viewing control conditions are ranked in the order of rating levels in each column.

4. The broadcast receiving device according to claim 3, wherein
the first and second viewing control tables are further configured to store the first and second viewing control conditions so that the first and second viewing control conditions are ranked in the order of rating levels from the lowest rating to the highest rating as the row number increases in each column.

5. The broadcast receiving device according to claim 4, further comprising
a third determination component configured to determine whether or not the viewing control is to be executed based on the second viewing control conditions of the second viewing control table when the second determination component determines that the first setup condition information includes the first viewing control execution indicator; and
a condition production component configured to produce second setup condition information corresponding to the second viewing control table when the third determination component determines that the viewing control is to be executed based on the second viewing control conditions of the second viewing control table.

6. The broadcast receiving device according to claim 5, wherein
the third determination component is further configured to receive an operation input and determine whether or not the viewing control is to be executed based on the second viewing control conditions of the second viewing control table in accordance with the operation input.

7. The broadcast receiving device according to claim 6, wherein
the condition production component is further configured to produce the second setup condition information in accordance with preset rules.

8. The broadcast receiving device according to claim 7, wherein
the condition production component is further configured to store the second setup condition information in the setup condition storage component.

9. The broadcast receiving device according to claim 8, further comprising
a maximum value calculation component configured to calculate a maximum row number value that is a maximum number of rows that store the first viewing control conditions for each of which the first viewing control execution indicator is set,
the condition production component being configured to produce the second setup condition information corresponding to the second viewing control table so that a second viewing control execution indicator indicating the viewing control is to be executed based on one of the second control conditions is set in the second setup condition information for at least one of the second viewing control conditions stored in rows having a row number less than or equal to the maximum row number value calculated by the maximum value calculation component.

10. The broadcast receiving device according to claim 1, further comprising
a third determination component configured to determine whether or not the viewing control is to be executed based on the second viewing control conditions of the second viewing control table when the second determination component determines that the first setup condition information includes the first viewing control execution indicator; and
a condition production component configured to produce second setup condition information corresponding to the second viewing control table when the third determination component determines that the viewing control is to be executed based on the second viewing control conditions of the second viewing control table.

11. The broadcast receiving device according to claim 10, further comprising
a maximum value calculation component configured to calculate a maximum row number value that is a maximum number of rows that store the first viewing control conditions for each of which the first viewing control execution indicator is set,
the condition production component being configured to produce the second setup condition information corresponding to the second viewing control table so that a second viewing control execution indicator indicating the viewing control is to be executed based on one of the second control conditions is set in the second setup condition information for at least one of the second viewing control conditions stored in rows having a row number less than or equal to the maximum row number value calculated by the maximum value calculation component.

12. A viewing control method for a broadcast receiving device for receiving a television broadcast, comprising:
providing a first viewing control table including first viewing control conditions for viewing control;
acquiring a second viewing control table including second viewing control conditions for the viewing control via the television broadcast;
determining whether or not the second viewing control table matches the first viewing control table;
determining whether or not first setup condition information corresponding to the first viewing control table includes a first viewing control execution indicator indicating that the viewing control is to be executed based on one of the first viewing control conditions of the first viewing control table, upon determining that the second viewing control table does not match the first viewing control table; and
displaying information indicating that the second viewing control table is newly acquired upon determining that the first setup condition information includes the first viewing control execution indicator.
